(19) United States
(12) Patent Application Publication
(10) Pub. No.: US 2017/0169453 A1
(43) Pub. Date: Jun. 15, 2017

(54) INDUSTRY BENCHMARK PROCESS

(71) Applicant: MASTERCARD INTERNATIONAL INCORPORATED, Purchase, NY (US)

(72) Inventors: Henry WEINBERGER, New York, NY (US); Shweta KHATTAR, Dwarka (IN); Nikhil MALGATTI, Stamford, CT (US); Anshul PANDEY, Gurgaon (IN); Ankur ARORA, New Delhi (IN)

(21) Appl. No.: 14/964,420

(22) Filed: Dec. 9, 2015

(51) Int. Cl. G06Q 30/02

(52) U.S. Cl. CPC G06Q 30/0205

(57) ABSTRACT

A system, method, and computer readable storage medium configured to the process, analyze, and model of large amounts of data resulting in improved functionality over a generic computer.

### BACKGROUND

Field of the Disclosure

Aspects of the disclosure relate in general to computer science. Aspects include an apparatus, system, method and computer readable storage medium to the process, analyze, and model of large amounts of data resulting in improved functionality over a generic computer.

Description of the Related Art

In the technical fields of computer analytics and operations research, pattern detection includes a number of methods for extracting meaning from large and complex data sets through a combination of operations research methods, graph theory, data analysis, clustering, and advanced mathematics.

Unlike machine learning, deep learning, or data mining, pattern detection is data agnostic, requiring only an ingestible data format to compute correlations in data.

Graph algorithms detect patterns of co-occurrence to create a holistic representation of connections a given set of data. Analysis has been applied to industries including transportation, manufacturing, and other fields, such as computer science.

Another different area of technology is computer modeling or computer simulation.

A computer simulation is a simulation, run on a single computer, or a network of computers, to reproduce behavior of a system. The simulation uses an abstract model (a computer model, or a computational model) to simulate the system. Computer simulations have become a useful part of mathematical modeling of many natural systems in physics (computational physics), astrophysics, climatology, chemistry and biology, human systems in economics, psychology, social science, and engineering. Simulation of a system is represented as the running of the system's model. It can be used to explore and gain new insights into new technology and to estimate the performance of systems too complex for analytical solutions.

Computer simulations vary from computer programs that run a few minutes to network-based groups of computers running for hours to ongoing simulations that run for days. The scale of events being simulated by computer simulations has far exceeded anything possible (or perhaps even imaginable) using traditional paper-and-pencil mathematical modeling. Over 10 years ago, a desert-battle simulation of one force invading another involved the modeling of 66,239 tanks, trucks and other vehicles on simulated terrain around Kuwait, using multiple supercomputers in the Department of Defense High Performance Computer Modernization Program. Other computer modeling examples include: a billion-atom model of material deformation, a 2.64-million-atom model of the complex maker of protein in all organisms called a “ribosome,” a complete simulation of the life cycle of mycoplasma genitalium, and the “Blue Brain” project at the École Polytechnique Fédérale de Lausanne (EPFL) in Switzerland to create the first computer simulation of the entire human brain, right down to the molecular level.

### SUMMARY

Embodiments include a system, device, method and computer readable medium configured to the process, analyze, and model of large amounts of data resulting in improved functionality over a generic computer.

A modeling apparatus comprises a network interface, a processor, and a presentation engine. The network interface retrieves merchant account locations for a predefined geographic area, based in part on either a merchant industry or merchant category code. The processor matches location metrics for each of the merchant account locations. The location metrics include: spend per account, transactions per account, and spend per transaction. The processor merges the location metrics with the merchant account locations. The processor calculates a mean and standard deviation for the location metrics across all the account locations for the predefined geographic area and for the merchant industry or merchant category code. The processor filters in locations within two standard deviations based on the location metrics. The processor filters out merchants with less than five merchant account locations. The processor maps the location metrics of one of the merchant locations against the mean for the location metrics calculated across all the merchant locations within 2 standard deviations for the predefined geographic area, resulting in a map of the location metrics of the one of the merchant account locations. The presentation engine presents the map of the location metrics of the one of the merchant account locations.

### BRIEF DESCRIPTION OF THE DRAWINGS

FIG. 1 depicts a block diagram of a modeling device configured to the process, analyze, and model of large amounts of data resulting in improved functionality over a generic computer.

FIGS. 2A-2B flowchart a method embodiment to the process, analyze, and model of large amounts of data resulting in improved functionality over a generic computer.

### DETAILED DESCRIPTION

In industry, a benchmarking is the process of comparing business performance to industry bests or performance by other companies. Typically, a company (either as a whole or a specific location) would like to know how it compares to its competition. Usually, comparing business performance between companies is difficult, as access to comparative business data is limited, and even when access to business data is available, generic computers are unable to adequately process the business data.

Aspects of the disclosure include a specialized computing device that results in greater data and information processing functionality when compared to a generic computer. Embodiments overcome a technical problem specifically arising in the realm of computer science and specify how interactions between elements are manipulated to yield a non-routine and non-conventional result, specifying how various databases and specific information are used to generate very specific information, resulting in the improved functionality.

Conventionally, to benchmark a company, market research companies recruit participants and gather information. Typically, thousands of respondents are contacted over weeks and months to conduct interviews through telephone, mail or the Internet.

Large corporations from around the world pay millions of dollars to research companies to collect data on public opinions, product reviews and consumer behavior by using these surveys. The completed surveys directly influence the development of products and services from these companies.

One of the problems inherent in survey information is that the honesty and correctness of survey responses directly affect the accuracy of a panel. It is also very important that the overall composition of the panel reflects the demographic and geographic characteristics of the broader consumer population in order for the data collected from the panel to reflect the overall marketplace.

One aspect of the disclosure includes the realization that a virtual panel of merchant performance may be constructed from the billions of financial transactions that occur in a payment network. An example payment network includes MasterCard International Incorporated of Purchase, N.Y. Financial transactions may include credit, debit, charge, prepaid payment card, checking, savings, balance-transfer transactions, and the like.

Another realization is that financial transaction data may be used to create stable merchant benchmarking products.

Another aspect of the disclosure includes the understanding that not all payment network financial transactions are applicable for use in a virtual panel.

Embodiments of the present disclosure include a system, method, and computer readable storage medium configured to the process, analyze, and model of large amounts of data resulting in improved functionality over a generic computer.

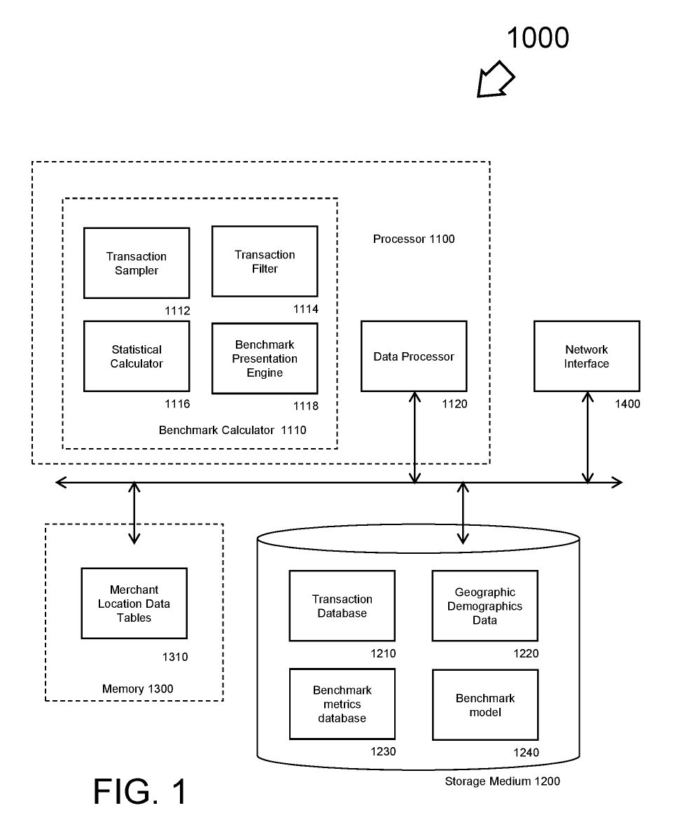

FIG. 1 illustrates an embodiment of a modeling device 1000 configured to the process, analyze, and model of large amounts of data resulting in improved functionality over a generic computer.

Modeling device 1000 may run a multi-tasking operating system (OS) and include at least one processor or central processing unit (CPU) 1100, a non-transitory computer readable storage medium 1200, computer memory 1300 and a network interface 1400. An example operating system may include Advanced Interactive Executive (AIX™) operating system, UNIX operating system, or LINUX operating system, and the like.

Processor 1100 may be a central processing unit, microprocessor, micro-controller, computational device or circuit known in the art. It is understood that processor may store data temporarily in a computer memory 1300. Computer memory 1300 may be a Random Access Memory (RAM).

As shown in FIG. 1, processor 1100 is functionally comprised of a benchmark calculator 1110 and a data processor 1120.

Benchmark calculator 1110 is a modeling environment configured to execute a benchmark model 1240. Furthermore, benchmark calculator 1110 may comprise: transaction sampler 1112, transaction filter 1114, statistical calculator 1116, and benchmark presentation engine 1118.

Transaction sampler 1112 is the element of processor 1100 to sample, slice, variable screen, and otherwise process a dataset of transaction data into manageable size.

Transaction filter 1114 enables processor 1100 to construct and execute filters for transaction data retrieved by transaction sampler 1112.

Statistical calculator 1116 is the portion of the processor 1100 that performs statistical analysis. For example, statistical calculator 1116 may be able to determine the total variation distance between two probability measures. In some embodiments, statistical calculator is configured to perform a Kolmogorov-Smirnov test (K-S test), Shapiro-Wilk test, Anderson-Darling test, or the like.

Benchmark presentation engine 1118 is the portion of processor 1100 to scale modeling information from a benchmark model 1240 and present the information to a user.

Data processor 1120 enables processor 1100 to interface with memory 1300, storage medium 1200, network interface 1400 or any other component not on the processor 1100. The data processor 1120 enables processor 1100 to locate data on, read data from, and write data to these components.

These structures may be implemented as hardware, firmware, or software encoded on a computer readable medium, such as storage medium 1200. Further details of these components are described with their relation to method embodiments below.

Memory 1300 may be any computer memory known in the art for volatile or non-volatile storage of data or program instructions. An example memory 1300 may be Random Access Memory (RAM). As shown, memory 1300 may store merchant location data tables 1310, for instance.

Computer readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer readable memory device as is known in the art for storing and retrieving data. Significantly, computer readable storage medium 1200 may be remotely located from processor 1100, and be connected to processor 1100 via a network such as a local area network (LAN), a wide area network (WAN), or the Internet.

In addition, as shown in FIG. 1, storage medium 1200 may also contain a transaction database 1210, benchmark metrics 1230, geographic demographics data 1220, and a benchmark model 1240. Transaction database 1210 is a database of payment card transactions at a payment network; the transaction database 1210 may contain all merchant accounts that have financial transactions within a determined time period. Benchmark model 1240 is configured to store the model or result of the benchmark calculator 1110. Benchmark metrics 1230 is a financial transaction metrics generated and applied by transaction filter 1114. Using Merchant Category Codes with payment account transactions, the benchmark calculator 1110 can determine the type of industry a financial transaction is taking place at. Geographic demographics data 1250 is private entity or census distribution information on the overall consumer universe. Geographic demographics data 1220 enables benchmark calculator 1110 to more accurately represent a specific geographical area. For example, if 1% of U.S. merchants are located in Cook County, Illinois, then 1% of a nation-wide benchmark model 1240 is derived from Cook County.

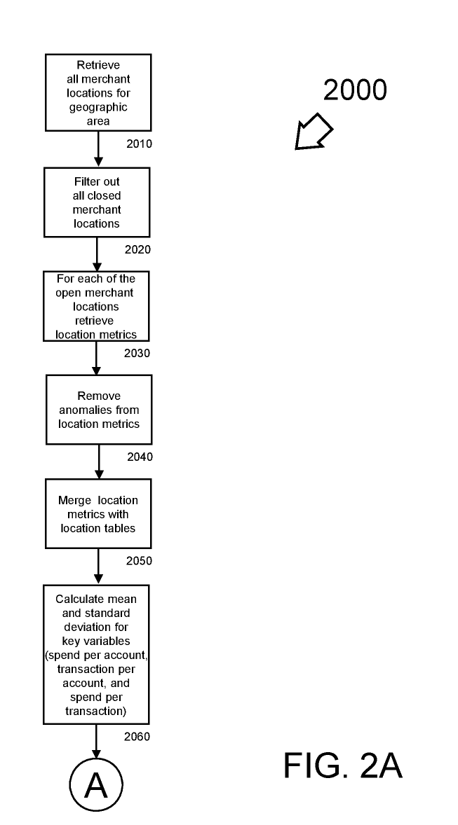

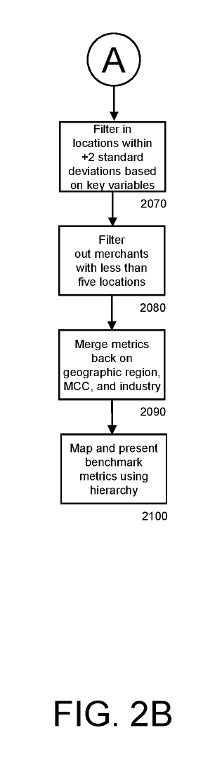

It is understood by those familiar with the art that one or more of these databases 1210-1240 may be combined in a myriad of combinations. These structures 1210-1240 may be any relational database known in the art, such as SQL, SQLite, MySQL, PosgreSQL, or the like. The function of these structures may best be understood with respect to the flowcharts of FIG. 2, as described below.

Network interface 1400 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1400 allows modeling device 1000 to communicate with acquirers, issuers and user computer systems.

We now turn our attention to method or process embodiments of the present disclosure depicted in FIGS. 2A-2B. It is understood by those known in the art that instructions for such method embodiments may be stored on their respective computer readable memory and executed by their respective processors.

FIGS. 2A-2B flowchart a modeling method 2000 embodiment to generate and determine a benchmark model 1240 in an in-memory modeling environment, constructed and operative in accordance with an embodiment of the present disclosure.

In order to produce a benchmark model 1240 that more accurately reflects overall merchant performance, the benchmark model 1240 is built from a subset of payment network transactions. That subset would be selected using a set of quotas for various geo-demographic and/or behavioral cells such that the sample of accounts used for the reports would be more representative of the merchant category in their spend activity.

Accounts may be classified in their activity based on Merchant Category Codes (MCC), which is used to classify a business by the type of goods or services it provides. Typically, a MCC is a four-digit number assigned to the merchant.

The transaction database 1210 contains a plurality of merchant records associated with a merchant or merchant location. Each merchant record includes purchase transactions made with payment accounts. It is understood that merchant account may have multiple purchase transaction records. The purchase transaction records include an account identification code (usually a payment account number), a date and time of the transaction, an amount of a transaction, and a merchant identifier. The merchant identifier indicates the merchant at which the transaction took place. From the merchant identified by the merchant identifier, a merchant category code can be determined.

As will be described below, benchmarking is a comparative process. In benchmarking performance by a merchant, the merchant is compared to other merchants in a similar line of business in a subject geographic area. The subject geographic area may be defined on a local, national or international area. The boundaries may be geographic or political. For example, the subject geographic area may be city, county, state, province, country, continental, or other geo-political area.

At block 2010, the transaction sampler 1112 retrieves all merchant locations for a subject geographic area, and may be assisted with the use of geographic demographics data 1220. In some embodiments, retrieval may be accomplished via network interface 1400. For example, if the interested subject geographic area were California, transaction sampler 1112 would retrieve all the merchant transactions for that state. The retrieval is location of merchant locations in the same line of business as the merchant to be benchmarked.

Closed merchant locations are removed so that comparisons may be made against active business locations. The transaction filter 1114 removes all closed merchant locations from the merchant transactions received by the transaction sampler 1112, block 2020.

For each of the open business locations determined above, location metrics are retrieved from benchmark metrics database 1230, block 2030. The location metrics include metrics of interest to a benchmarked company, including, but not limited to: spend per account, transactions per account, spend per transaction. These metrics may be available for specific times of the day, for example 6 am to 11 am, 11 am to 3 pm, 3 pm to 6 pm, 9 pm to midnight, midnight to 6 am, or by hourly or other time-period basis. The metrics may also be broken down by days of the week. Additionally benchmark metrics may include repeat customers, average number of days between merchant transactions, or other known metrics. Additionally, benchmark metrics may also be broken down by date; for example, the benchmark metrics may be applicable for a particular month or fiscal quarter.

Metric anomalies are removed from the location metrics by the transaction filter 1114, block 2040. Metric anomalies are statistical abnormalities that would skew the benchmark process. Examples of metric anomalies include negative or missing spend transactions. Other metric anomalies may be metrics with values not in range of acceptable values. For example, for restaurants with only dinner service metrics in the 6 am-11 am hours would be an outlier. Another outlier could be an average ticket 10 times higher, than the highest in the industry.

Transaction filter 1114 merges the location merchants into merchant location data tables 1310. This allows the merchant location data tables 1310 to be updated with MC, industry, and other metrics.

At block 2060, the statistical calculator 1116 calculates mean and standard deviation for key variables. These key variables include: spend per account, transaction per account, and spend per transaction for each merchant location.

At block 2070, transaction filter 1114 filters in merchant locations within +2 standard deviations based on the key variables, and then filters out merchant with less than five locations, block 2080.

At block 2090, the statistical calculator 1116 merges the metrics back on geographic region, merchant category code, and industry, which results in the benchmark model 1240, and allows update of the benchmark metrics database 1230.

The resulting benchmark model 1240 models the industry performance in the geographic distribution based on the industry segment, block 2080. The benchmark model 1240 may then be stored on a non-transitory computer-readable storage medium. The resulting benchmark model 1240 may be the underlying driver to produce accurate analytics within a myriad of informational products. For example, the resulting benchmark model 1240 is able to monitor industry, merchant, and payment account issuer performance.

Benchmark presentation engine 1118 may then map and present the benchmark metrics using the following hierarchy: country or geographic state merchant category codes, country or geographic state industry, country merchant category code, and country industry. Presentation may occur using electronic display to screen, transmission as a report via the network interface 1400, or printed as a report.

The previous description of the embodiments is provided to enable any person skilled in the art to practice the disclosure. The various modifications to these embodiments will be readily apparent to those skilled in the art, and the generic principles defined herein may be applied to other embodiments. Thus, the present disclosure is not intended to be limited to the embodiments shown herein, but is to be accorded the widest scope consistent with the principles and novel features disclosed herein.

What is claimed is:

1. A modeling method comprising:
retrieving merchant account locations for a predefined geographic area, based in part on either a merchant industry or merchant category code;
matching location metrics for each of the merchant account locations with a processor, the location metrics including: spend per account, transactions per account, and spend per transaction;
merging the location metrics with the merchant account locations with the processor;
calculating, with the processor, a mean and standard deviation for the location metrics across all the account locations for the predefined geographic area and for the merchant industry or merchant category code with the processor;
filtering in locations within two standard deviations based on the location metrics with the processor;
filtering out merchants with less than a pre-determined minimum number of merchant account locations with the processor;
mapping the location metrics of one of the merchant locations against the mean for the location metrics calculated across all the merchant locations within 2 standard deviations for the predefined geographic area, resulting in a map of the location metrics of the one of the merchant account locations;
presenting the map of the location metrics of the one of the merchant account locations.

2. The modeling method of claim 1, further comprising:
filtering out closed merchant account locations with the processor.

3. The modeling method of claim 2, further comprising:
filtering out anomalies from the location metrics with the processor.

4. The modeling method of claim 3, further comprising:
merging the map of the location metrics of the one of the merchant account locations back on the predefined geographic area.

5. The modeling method of claim 4, wherein the location metrics is available for specific times of the day.

6. The modeling method of claim 4, wherein the location metrics is available for specific days of the week.

7. The modeling method of claim 4, wherein the location metrics include repeat customers or average number of days between merchant transactions.

8. A modeling apparatus comprising:
a network interface configured to retrieve merchant account locations for a predefined geographic area, based in part on either a merchant industry or merchant category code;
a processor configured to match location metrics for each of the merchant account locations, the location metrics including: spend per account, transactions per account, and spend per transaction, to merge the location metrics with the merchant account locations, to calculate a mean and standard deviation for the location metrics across all the account locations for the predefined geographic area and for the merchant industry or merchant category code, to filter in locations within two standard deviations based on the location metrics, to filtering out merchants with less than five merchant account locations, to the location metrics of one of the merchant locations against the mean for the location metrics calculated across all the merchant locations within 2 standard deviations for the predefined geographic area, resulting in a map of the location metrics of the one of the merchant account locations; and,
a presentation engine configured to present the map of the location metrics of the one of the merchant account locations.

9. The modeling apparatus of claim 8, further comprising:
filtering out closed merchant account locations with the processor.

10. The modeling apparatus of claim 9, further comprising:
filtering out anomalies from the location metrics with the processor.

11. The modeling apparatus of claim 10, further comprising:
merging the map of the location metrics of the one of the merchant account locations back on the predefined geographic area.

12. The modeling apparatus of claim 11, wherein the location metrics is available for specific times of the day.

13. The modeling apparatus of claim 11, wherein the location metrics is available for specific days of the week.

14. The modeling apparatus of claim 11, wherein the location metrics include repeat customers or average number of days between merchant transactions.

15. A modeling apparatus comprising:
means for retrieving merchant account locations for a predefined geographic area, based in part on either a merchant industry or merchant category code;
means for matching location metrics for each of the merchant account locations, the location metrics including: spend per account, transactions per account, and spend per transaction;
means for merging the location metrics with the merchant account locations;
means for calculating, with the processor, a mean and standard deviation for the location metrics across all the account locations for the predefined geographic area and for the merchant industry or merchant category code;
means for filtering in locations within two standard deviations based on the location metrics;
means for filtering out merchants with less than five merchant account locations;
means for mapping the location metrics of one of the merchant locations against the mean for the location metrics calculated across all the merchant locations within 2 standard deviations for the predefined geographic area, resulting in a map of the location metrics of the one of the merchant account locations;
means for presenting the map of the location metrics of the one of the merchant account locations.

16. The modeling apparatus of claim 15, further comprising:
means for filtering out closed merchant account locations with the processor.

17. The modeling apparatus of claim 16, further comprising:
means for filtering out anomalies from the location metrics with the processor.

18. The modeling apparatus of claim 17, further comprising:
means for merging the map of the location metrics of the one of the merchant account locations back on the predefined geographic area.

19. The modeling apparatus of claim 18, wherein the location metrics is available for specific times of the day.

20. The modeling apparatus of claim 18, wherein the location metrics is available for specific days of the week.
